(19) United States
(12) Patent Application Publication
(10) Pub. No.: US 2010/0166057 A1
(43) Pub. Date: Jul. 1, 2010

(54) Differential Data Representation for Distributed Video Coding

(76) Inventors: Gregory Huchet, Ottawa (CA); Jean-Yves Chouinard, Quebec (CA); Demin Wang, Ottawa (CA); Andre Vincent, Gatineau (CA)

Correspondence Address: TEITELBAUM & MACLEAN, 280 SUNNYSIDE AVENUE, OTTAWA, ON, K1S 0R8, CA

(21) Appl. No.: 12/648,444

(22) Filed: Dec. 29, 2009

Related U.S. Application Data
(60) Provisional application No. 61/141,105, filed on Dec. 29, 2008.

(51) Int. Cl. H04N 7/12

(52) U.S. Cl. 375/240.01; 375/E07.026

(57) ABSTRACT

The invention relates to improving the performance of DVC systems using a differential adaptive-base representation of video data to be transmitted, wherein frame data are truncated to the least significant digits in a base-B numeral system, wherein the base B is adaptively determined at the DVC receiver based on a side information error estimate.

### CROSS-REFERENCE TO RELATED APPLICATIONS

The present invention claims priority from U.S. Provisional Patent Application No. 61/141,105 filed Dec. 29, 2008, entitled “Differential Representation Method for Efficient Distributed Video Coding”, which is incorporated herein by reference.

### TECHNICAL FIELD

The present invention generally relates to methods and devices for distributed source coding, and in particular relates to improving the transmission efficiency of distributed video coding systems by using a differential representation of source data based on side information.

### BACKGROUND OF THE INVENTION

Traditional video coding algorithms such as H.264, MPEG-2, and MPEG-4 are suited for situations, such as in broadcasting, in which the transmitter can utilize complicated equipment to perform extensive encoding, allowing the decoding to be kept relatively simple at the user end. The traditional video coding algorithms are less suitable for situations where the encoding is done at the user end which cannot host a computationally expensive encoder. Examples of such situations include wireless video sensors for surveillance, wireless PC cameras, mobile camera phones, and disposable video cameras. In particular, video sensor networks have been envisioned for many applications such as security surveillance, monitoring of disaster zones, domestic monitoring applications, and design of realistic entertainment systems involving multiple parties connected through the network. The rapidly growing video conferencing involving mobile communication of a large number of parties is another example.

These situations require a distributed video coding (DVC) system where there could be a large number of low-complexity encoders, but one or a few higher-complexity decoders. In particular, Wyner-Ziv coding of source video data is among the most promising DVC techniques; it finds its origin in Slepian-Wolf theorem, according to which two correlated independent identically distributed (i.i.d) sequences X and Y can be encoded losslessly with the same rate as that of the joint encoding as long as the collaborative decoders are employed. Wyner and Ziv extended this theorem to the lossy coding of continuous-valued sources. According to Slepian-Wolf and Wyner-Ziv theorems, it is possible to exploit correlations between the sequences only at the decoder. For example, the temporal correlation in video sequences can be exploited by shifting motion estimation from the encoder to the decoder, and low-complexity video coding is thus made possible. In DVC systems, the decoding of a source frame is carried out utilizing additional information, known as side information. This side information, created at the decoder, could be considered as a noisy version of the source frame. The side information is used to help the decoder to reconstruct the compressed source frame.

In a typical DVC system, a source frame is encoded by an intraframe coding process that produces data bits and parity bits and the parity bits are sent to the decoder. At the DVC decoder, the decoding of the source frame is carried out utilizing additional information, known as side information. This side information, which is created at the decoder as a predicted image generated by, for example, interpolation or extrapolation from other frames, is correlated with the source frame and could be considered as a noisy version of the source frame. The side information and the parity bits are used by the decoder to reconstruct the source frame.

More specifically, in a typical DVC system a video image sequence is divided into Wyner-Ziv (WZ) frames, to which the above coding and decoding process is applied, and key (K) frames, to which conventional intraframe coding and decoding are applied. A discrete cosine transform (DCT), or other suitable lossless transform, may be used to transform each Wyner-Ziv frame to the coefficient domain, the coefficients are grouped into bands, the coefficients in the k-th band are quantized by a 2^{M}^{ₖ}-level quantizer, the quantized coefficients qₖ are expressed in fixed numbers of bits, and the bit planes are extracted and supplied to a Slepian-Wolf encoder, which is a type of channel encoder that produces the data bits and parity bits. The parity bits are stored in a buffer for transmission to the decoder, while the data bits are discarded. The decoder generates the predicted image, applies a DCT to convert the predicted image to the coefficient domain, groups the coefficients into bands, and inputs the coefficients in each band as side information to a Slepian-Wolf decoder. The Slepian-Wolf decoder requests the parity bits it needs as error-correcting information to correct prediction errors in the side information, thereby decoding the parity bits. If necessary, further parity bits can be requested and the turbo decoding process can be repeated until a satisfactory decoded result is obtained. An inverse discrete cosine transform (IDCT) is then used to reconstruct the image; see, for example, Aaron et al., ‘Transform-Domain Wyner-Ziv Codec for Video’, Proc. SPIE Visual Communications and Image Processing, 2004, which is incorporated herein by reference.

For a given channel coding method in the Slepian-Wolf encoder, the difference between the source image and the side information corresponding thereto determines the compression ratio of the transmitted WZ frames. A small difference requires a small number of parity bit to encode, i.e. protect, the source image. With the existing DVC schemes, all bits of the quantized source picture, or the quantized transform coefficients of the source, are encoded with channel coding after quantization. This is because all bits of a side information pixel may be different from those of the corresponding source pixel even though the difference of the values of the two pixels is very small.

An object of the present invention is to provide a method for improving the transmission efficiently in a DVC system by utilizing correlations between the source video data and the side information to reduce the number of bits per frame to be encoded, and an apparatus implementing such method.

### SUMMARY OF THE INVENTION

In accordance with the invention, a method is provided for encoding source video signal in a distributed video coding (DVC) system comprising a DVC transmitter and a DVC receiver, the DVC receiver comprising a DVC decoder utilizing side information for decoding received video signal. The method comprises: a) obtaining, at the DVC transmitter, source frame data X from the source video signal, the source frame data X comprising source frame values for a frame of the source video signal; b) obtaining a base B for the source frame data X, wherein the base B is an integer number generated in dependence on an error estimate Em for side information Y obtained at the DVC receiver for the source frame data X; c) truncating the source frame data X to obtain truncated frame data Xtr comprised of truncated frame values, wherein each truncated frame value corresponds to a least significant digit of one of the source frame values in a base B numeral system; and, d) generating a transmitter video signal from the truncated frame data Xₜᵣ for transmitting to the DVC receiver. In one aspect of the invention, step b) comprises computing for each of the source frame values a remainder on division thereof by B, and representing said remainder with at most m bits, wherein m is a smallest integer no less the log₂(B).

In accordance with further aspect of this invention, the method comprises the steps of e) obtaining at the DVC receiver the side information Y for the source frame data X, said side information comprising side information values; f) obtaining at the DVC receiver the error estimate Eₘ for the side information Y; g) computing the base B from the error estimate Eₘ, and transmitting information indicative of the base B to the DVC transmitter; h) receiving the transmitter video signal at the DVC receiver and obtaining therefrom the truncated frame data Xₜᵣ corresponding to the source frame data X; i) restoring the source frame data from the received truncated frame data to obtain restored frame data Xᵣ using the side information Y and the error estimate Eₘ; and, j) forming an output video signal from the restored frame data for presenting to a user.

In accordance with another aspect of this invention there is provided an apparatus for encoding a source video signal in a distributed video coding (DVC) system; the apparatus comprises a source signal processor for receiving the source video signal and for obtaining therefrom source frame data X comprising source frame values for a frame of the source video signal; a data truncator for converting the source frame values into truncated frame values to generate truncated frame data Xₜᵣ, wherein the truncated frame values correspond to least significant digits of the source frame values in a base B numeral system, the data truncator configured for receiving a feedback signal indicative of the base B from a DVC receiver; and, a transmitter signal generator for generating a transmitter video signal from the truncated frame values for transmitting to the DVC receiver.

Another feature of the present invention provides an apparatus for decoding the transmitter video signal in the DVC system, comprising: a side information generator for generating side information Y for the source frame data X, the side information comprising side information values related to the source frame values; an error estimator for estimating an error Eₘ of the side information Y, and for computing therefrom the base B for communicating to the transmitter apparatus; an input signal processor for receiving the transmitter video signal and obtaining therefrom received truncated frame data Xᵣₜᵣ; and, a frame data restorer coupled to the side information generator and the error estimator for computing restored frame data X, from the received truncated frame data Xᵣₜᵣ based on the side information Y and the error estimate Eₘ.

### BRIEF DESCRIPTION OF THE DRAWINGS

The invention will be described in greater detail with reference to the accompanying drawings which represent preferred embodiments thereof, in which like elements are indicated with like reference labels, and wherein:

FIG. 1 is a histogram illustrating an exemplary distribution of errors in the side information according to frequency of their occurrences;

FIG. 2 is a conversion table for frame values and corresponding truncated frame values illustrating different representations thereof according to the present invention;

FIG. 3 is a flowchart representing general steps of the method for transmitting video data in a DVC system that are performed at a DVC transmitter according to an embodiment of the present invention;

FIG. 4 is a flowchart representing general steps of the method for transmitting video data in the DVC system that are performed at a DVC receiver according to an embodiment of the present invention;

FIG. 5 is a general block diagram of a DVC system according to an embodiment of the present invention for implementing the method of FIGS. 3 and 4;

FIG. 6 is a block diagram of an embodiment of the DVC transmitter according to the present invention;

FIG. 7 is a block diagram of an embodiment of the DVC receiver according to the present invention;

FIG. 8 is a graph illustrating simulated rate-distortion performance for an exemplary DVC system utilizing the frame data representation according to the present invention (305) compared to prior art DVC systems (303, 304) and to base-line performance curves for the H.264 codec (301, 302) for the Foreman video sequence;

FIG. 9 is a graph illustrating simulated rate-distortion performance for an exemplary DVC system utilizing the frame data representation according to the present invention (405) compared to prior art DVC systems (403, 404) and to base-line performance for the H.264 codec (401, 402) for the Coastguard video sequence).

### DETAILED DESCRIPTION

The following general notations are used in this specification: A mod B denotes A modulo-B arithmetic, so that by way of example, 5 mod 4=1, 9 mod 4=1, and 4 mod 4=0. The notation (A)B denotes a number A in a base-B numeral system, so that for example (11)10 refers to a decimal number eleven, (11)2 refers to a decimal number three, and (11)8 refers to a decimal number nine. The notation x represent the function ceiling(x), and denotes the smallest integer not less than x, so that for example 5.1=5.9=6.

In addition, the following is a partial list of abbreviated terms and their definitions used in the specification:

ASIC Application Specific Integrated Circuit

BER Bit Error Rate

PSNR Peak Signal to Noise Ratio

DSP Digital Signal Processor

FPGA Field Programmable Gate Array

DCT Discrete Cosine Transform

IDCT Inverse Discrete Cosine Transform

DVC Distributed Video Coding

CRC Cyclic Redundancy Check

LDPC Low-Density Parity-Check

ECE Error Correction Encoder

ECD Error Correction Decoder

The term “symbol” is used herein to represent a digital signal that can assume a pre-defined finite number of states. A binary signal that may assume any one of two states is conventionally referred to as a binary symbol or bit. Notations ‘1’ and ‘0’ refer to a logical state ‘one’ and a logical state ‘zero’ of a bit, respectively. A non-binary symbol that can assume any one of 2ⁿ states, where n is an integer greater than 1, can be represented by a sequence of n bits.

Unless specifically stated otherwise and/or as is apparent from the following discussions, terms such as “processing,” “operating,” “computing,” “calculating,” “determining,” or the like, refer to the action and processes of a computer, data processing system, logic circuit or similar processing device that manipulates and transforms data represented as physical, for example electronic, quantities.

The terms “connected to”, “coupled with”, “coupled to”, and “in communication with” may be used interchangeably and may refer to direct and/or indirect communication of signals between respective elements unless the context of the term's use unambiguously indicates otherwise.

In the following description, reference is made to the accompanying drawings which form a part thereof and which illustrate several embodiments of the present invention. It is understood that other embodiments may be utilized and structural and operational changes may be made without departing from the scope of the present invention. The drawings include flowcharts and block diagrams. The functions of the various elements shown in the drawings may be provided through the use of dedicated data processing hardware such as but not limited to dedicated logical circuits within a data processing device, as well as data processing hardware capable of executing software in association with appropriate software. When provided by a processor, the functions may be provided by a single dedicated processor, by a single shared processor, or by a plurality of individual processors, some of which may be shared. The term “processor” should not be construed to refer exclusively to hardware capable of executing software, and may implicitly include without limitation, logical hardware circuits dedicated for performing specified functions, digital signal processor (“DSP”) hardware, application specific integrated circuits (ASICs), field-programmable gate arrays (FPGAs), read-only memory (“ROM”) for storing software, random access memory (“RAM”), and non-volatile storage.

One aspect of the invention relates to reducing the size of information to be transmitted in the DVC system from a DVC transmitter to a DVC receiver; this is accomplished by using a differential representation of the source data that accounts for the side information available at the DVC receiver. With this method, a source pixel or transform coefficient is represented as the sum of a prediction and a residual according to a maximum difference Eₘₐₓ between the source picture and side information. The DVC encoder needs to encode and transmit only the residual to the decoder. The residual requires only about log(2*Eₘₐₓ+1) bits. The source pixel can be perfectly reconstructed from the coding result with the help of the side information in the decoder.

By way of example we first consider a DVC system utilizing bit-plane to transmit a source picture to a user. In the following we will denote a set of values representing the source picture as X, and a set of values representing the side information for the source picture as Y, with each value in X having a corresponding value in Y. The word “picture” is used herein interchangeably with the word “frame” to refer to a set of data, such as a 2-dimensional array, representing a digital image; it may refer for example to one frame in a sequence of frames of a video signal. The bit plane extraction typically requires binary representation of the frame values in X and Y. With a natural binary representation of X and Y, a following problem arises: even if the value of two collocated pixels within X and Y differs by 1, their binary representation is different for most of the bits. By way of example, consider a pixel that has a value 63 in X, while a co-located pixel in Y has a value of 64, both in the decimal notation; although the difference between the source pixel value and its approximation in Y is only 1, their binary representations will differ in most of the bit positions, as illustrated at the RHS (right hand side) of the following equations (1) and (2):

X:(63)10=(00111111)2, (1)

Y:(64)10=(01000000)2. (2)

Consequently, the side information for the corresponding bit position will have to be corrected at the DVC receiver for most of the bit-planes. Disadvantageously, the correlation between each bit-plane of the source data and the side information is reduced, requiring the transmission of a greater number of parity bits, with an associated increase in the bitrate for the transmission between the DVC transmitter and the DVC receiver.

The Gray representation of binary numbers, also known as the reflected binary code or the Gray code, provides a partial solution to this problem. The Gray binary representation is a binary numeral system where two successive values differ in only one bit. Therefore, it increases the correlation between X and Y, as illustrated for the considered exemplary pixel values by the following equations (3) and (4), assuming an 8-bit binary representation:

X:(63)10=(00100000)2, (3)

Y:(64)10=(01000000)2. (4)

Although this representation results in a reduction of the transmission bitrate, it does not eliminates errors from any of the transmitted bit-planes, even if it reduces the over-all number of bit-plane errors. Accordingly, the encoder at the DVC transmitter has to transmit information related to each of the bit-planes, including the most significant bit-plane.

Advantageously, the differential representation of the source data according to the present invention increases the correlation between the transmitted data and the side information related thereto, so that the size of the information that needs to be transmitted from the DVC transmitter to the DVC receiver is decreased. In particular, the transmission of information related to the most significant bits of X is no longer required, as the differential representation of the source data according to the present invention concentrates differences with the side information over the less significant bits. The differential representation may be used directly inside the Slepian-Wolf encoder and decoder of the DVC system.

The differential representation of the present invention maybe understood by noting that, in the exemplary situation represented by equations (1) to (4), there is no need for the transmitter to transmit the tens digit of the pixel value, i.e. “6”, since this digit of the corresponding pixel value in the side information Y is already correct, and therefore it would be sufficient to transmit only the last digit, i.e. “3”, to correct the error in the side information value “64”. It follows that for a binary transmission, only half of the bits representing the source pixel values will need to be transmitted, so that only n/2 bits of each n-bit word representing the pixel values in X need to be transmitted.

In the above given example, we assumed that the difference in pixel value between X and Y did not exceed the tens digit in the decimal numeric system, and that the accuracy of the side information is known to the transmitter; however, neither of these two assumptions generally holds in a conventional DVC system. Accordingly, the present invention provides a substantially two-part approach, wherein the DVC receiver obtains information about the accuracy of the side information Y and passes this information to the DVC transmitter, and the DVC transmitter uses this information to truncate the source data values in X so as to reduce the size of source information that needs to be communicated to the DVC receiver.

According to one aspect of the invention, each value in the source data X may be represented in a base-B numeral system, wherein the base B depends on a maximum error Eₘₐₓ of the side information according to the equation

B=2·(Eₘₐₓ+1) (5)

wherein the maximum error may be defined according to the equation

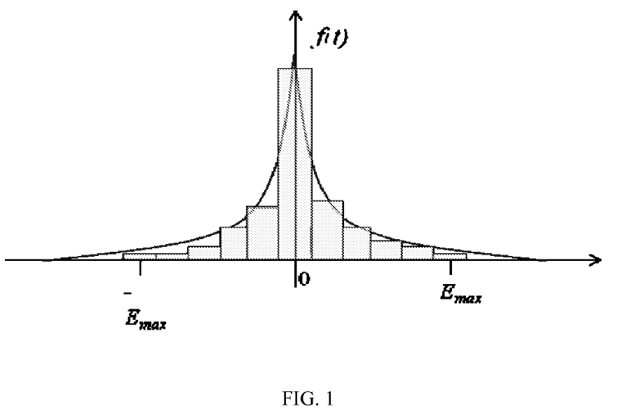

Eₘₐₓ=max {|X−Y|}≡maxᵢ {|X(i)−Y(i)|}, (6)

where maximum is taken across all co-located pixel positions i in X and Y, or all related pairs of transform coefficients corresponding to a same transform index i. Here, we use the notation X={X(i)} to represent a plurality, or a set, of source values X(i) that together form the source data X. In the context of this specification, symbolic notations representing operations on data sets such as X and Y are understood as element-by-element operations, if not stated otherwise. By way of example, FIG. 1 illustrates a Laplacian distribution function f for the side information error e(i)=[X(i)−Y(i)] for the plurality of pixels in one frame. Note that the base B and the maximum side information error Eₘₐₓ are both integers.

Advantageously, if both the source data X and the side information Y are represented in the base-B numeral system, they may differ only in the units digits of the respective values; therefore, only the units digits of the base B source data X, or coding information related thereto, need to be transmitted to the receiver. More particularly, only up to m=log₂(B) bits are needed to represent each value in the source data X for transmission to the receiver. The value of Eₘₐₓ may be estimated at the receiver and transmitted to the encoder along a feedback transmission channel.

Representing the values in X in the base-B numeric system and discarding all but the least significant digit is equivalent to truncating each value in X in the base B according to equation (7), i.e. computing a remainder Xₜᵣ on division of said value by B:

Xₜᵣ=X mod B. (7)

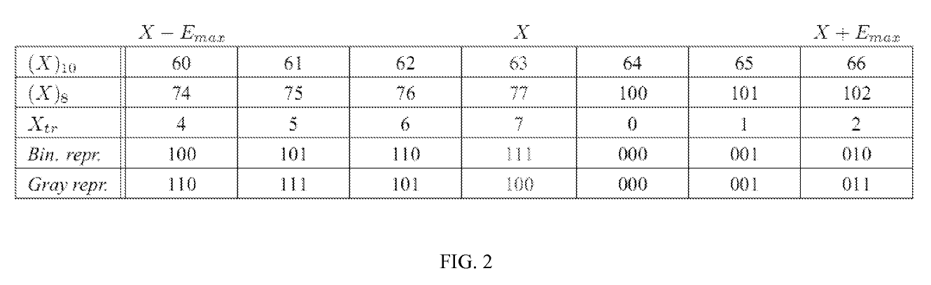

The operation described by equation (7) will also be referred herein as the base-B encoding. The truncated values Xₜᵣ may then be converted to the Gray binary representation before it is transmitted to the decoder. Note that the operation (7) is a differential operation, and therefore the result of this operation, i.e. the truncated values Xₜᵣ, may be seen as a differential representation of the source data, from which a “maximum error” side information is subtracted. In this representation, each frame value is represented by a codeword (Xₜᵣ(i))2 of m=log₂(B) bits, which is typically smaller than the number of bits n used to represent each value in the source frame data X, as long as Eₘₐₓ is sufficiently smaller than the maximum allowable range of the source frame data X. By way of example, the source frame data X are represented by 8 bit words, i.e. may vary between 0 and 255 (decimal), and Eₘₐₓ for a particular frame is found to be 3, resulting in B=8, and m=3. Further by way of example, FIG. 2 provides a table illustrating different representations of the source frame values in the range of X−Eₘₐₓ to X+Eₘₐₓ, for an exemplary value of X=63, with the first row providing the decimal representation, the second row providing the base-B representation, the third row providing corresponding base-B truncated frame values Xₜᵣ, and the forth and fifth rows providing the natural and Gray binary representation of the truncated frame values, respectively. Advantageously, in this example each source frame value may be fully represented at the transmitter by a 3-bit word rather than by an 8 bit word, reducing the required transmission bit rate by more than 2.5 times.

The source frame data X may be restored at the DVC receiver from the truncated frame data Xₜᵣ based on the following equations:

X=Y+q, (8)

q=Eₘₐₓ−(Yₜᵣ−Xₜᵣ+Eₘₐₓ)mod B. (9)

Here q is a side information correction factor, Yₜ, is the truncated side information that may be computed using the same base B as used to compute the truncated source data:

Yₜᵣ=Y mod B, (10)

The process of restoring the source frame data X from the truncated frame data Xₜᵣ will be referred to herein also as the base-B decoding. Advantageously, the base-B decoding according to equations (8), (9) works also for negative values of X, so that the bit sign transmission may be avoided. Further details are provided in a paper “Adaptive source representation for distributed video coding”, authored by the inventors of the present invention and presented at 2009 IEEE International Conference on Image Processing (ICIP 2009), November 2009, paper MA.L1.5, which is incorporated herein by reference.

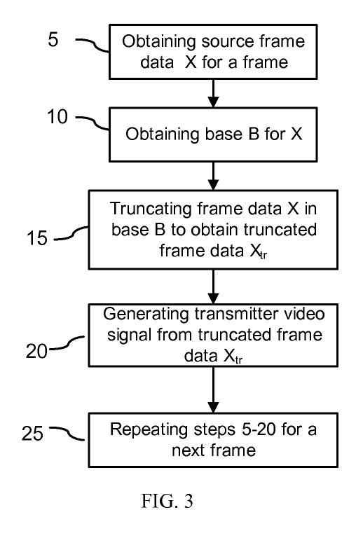

Accordingly, one aspect of the present invention provides a method for encoding and transmitting source video signal in a DVC system including a DVC transmitter and a DVC receiver, which utilizes the aforedescribed compact differential representation of the source video data, said compact differential representation being responsive to receiver feedback, to reduce the size of transmitted information and the associated transmission bitrate. An embodiment of this method is generally illustrated in a flowchart of FIG. 3, and includes the following general steps.

In a first step 5, source frame data are obtained from the source video signal at the DVC transmitter, the frame data X representing a frame of the input video signal and comprising frame values X(i). As understood herein, the source frame data X may refer to a set of pixel values of a frame, or any data representing the frame or a portion thereof, such as quantized pixel values, transform coefficients of a lossless transform such as DCT, or quantized transform coefficients.

In step 10, a base B is obtained for the source frame data, wherein the base B is an integer number generated in dependence on an error estimate Eₘ for side information Y obtained at the DVC receiver for the source video data. This step may include receiving at the DVC transmitter information related to the error estimate Eₘ from the DVC receiver. For example, this may include receiving a feedback signal from the DVC receiver representing a current value of the base B.

In step 15, the source frame values X are converted into truncated frame values Xₜᵣ, wherein the truncated frame values correspond to least significant digits of the frame values X in a base B numeral system.

In step 20, a transmitter video signal is generated from the truncated frame values Xₜ, for transmitting to the DVC receiver.

In step 25, steps 5 to 20 may be repeated for a next frame of the source video signal, which may include obtaining a new value of the base B, responsive to a new value of the side information error estimate Eₘ at the DVC receiver.

Thus, according to one aspect of the present invention, the base-B encoding is performed adaptively to the image content of the source video signal, as the accuracy of the side information may differ from frame to frame. Note that in some embodiments of the method, more than one values of the side information error estimate Eₘ may be generated at the DVC receiver, each related to a different portion of the frame data, resulting in the generation of more than one values of the base B per frame. In such embodiments, step 15 includes utilizing different values of the base B for different portions of the frame data to generate the truncated frame data.

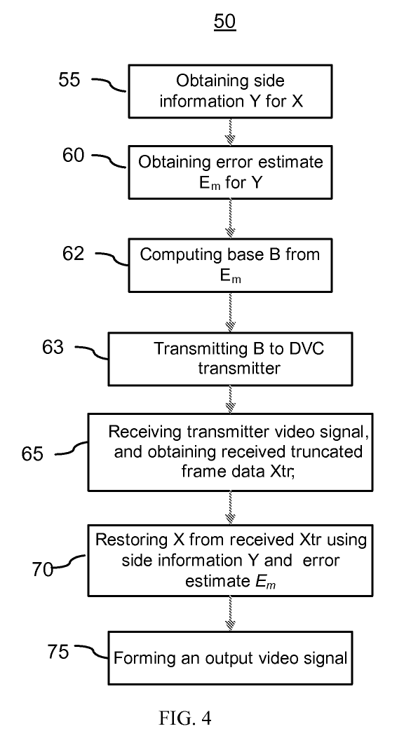

The aforedescribed method steps 5-25 may all be performed at the DVC receiver, resulting in the generation of the transmitter video signal in step 20. Referring now to FIG. 4, a flowchart is provided illustrating general steps that may be performed at the DVC receiver for processing, e.g. decoding, the transmitter video signal generated in step 20 of FIG. 3. These steps may be as follows.

In step 55, the side information Y is obtained for the source frame data X; this side information may be viewed as an approximation to the frame data X, and may be computed by extrapolation and/or interpolation from previously decoded frame data, utilizing correlation properties thereof as known in the art, see for example an article by B. Girod et al, entitled “Distributed Videro Codiung,” Proc. IEEE, vol. 93, No. 1, January 2005, which is incorporated herein by reference.

In step 60, the error estimate Eₘ of the side information Y is obtained. In one embodiment, the error estimate Eₘ may be computed by estimating the maximum side information error Eₘₐₓ as defined by equation (6), based on previously decoded frames and the side information related thereto. Once the error estimate Eₘ is computed, a current value of the base B is generated from Eₘ in step 62, for example based on equation (5). In step 63, information indicative of the base B and/or Eₘ is transmitted to the DVC transmitter. The transmitted value of the base B is then used by the DVC transmitter to obtain the truncated frame data X_{X}, as described hereinabove with reference to FIG. 3.

In step 65, the truncated frame data Xₜᵣ are obtained from the transmitter video signal received at the DVC receiver. In step 70, the source frame data X are restored by correcting the side information Y using the received truncated frame data X_{ft}, as described by equations (8) and (9). This step may include computing the base-B truncated side information Yₜᵣ in accordance with equation 10. An optional step 75 includes forming an output video signal from the restored frame data Xₜ for providing to a user in a desired format.

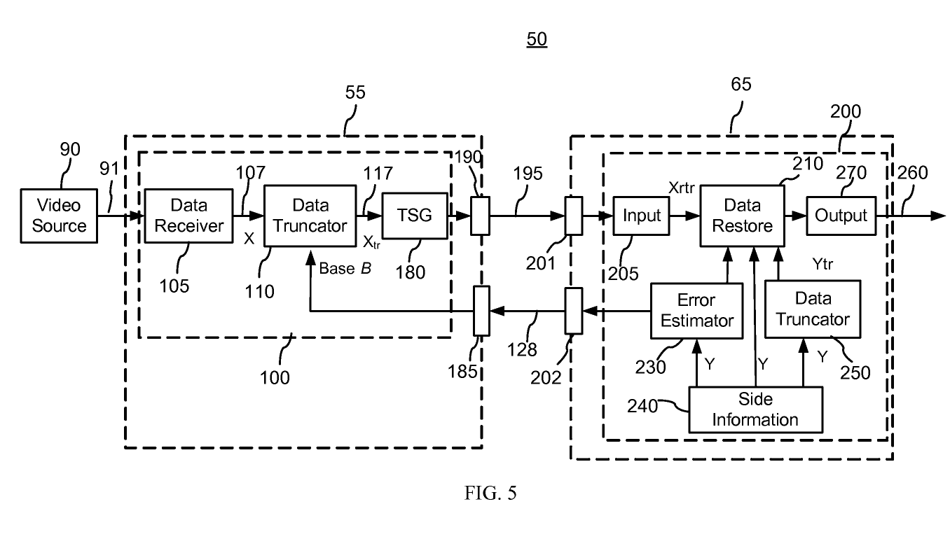

With reference to FIG. 5, there is generally illustrated a DVC system 50 according to an embodiment of the present invention, which implements the aforedescribed method for transmission of the source video signal utilizing the adaptive differential data representation according to an embodiment of the present invention.

In the DVC system 50, a DVC transmitter 55 and a DVC receiver 65 communicate with each other, for example wirelessly, to transmit a source video signal 91 from a video source 90 to a remote user (not shown). The video source 90 may be, for example, in the form of a video camera, and the source video signal 91 may carry a sequence of video frames, each video frame representing a digitized image of a scene or an object captured at a different time, so that there is a certain degree of correlation between successive frames. The DVC transmitter 55 includes an encoding apparatus 100, also referred to herein as the DVC encoder 100, for encoding the source video signal 91, and a transmitting-receiving interface (TRI) 190,185 having a signal transmitting unit 190, and a signal receiving unit 185, for example in the form of a wireless transmitter and a wireless receiver as known in the art. Similarly, the DVC receiver 65 includes a decoding apparatus 100, also referred to herein as the DVC decoder 200, and a receiving-transmitting interface (RTI) 201,202 having a signal receiving unit 201, such as a wireless receiver, and a signal transmitting unit 202, such as a wireless transmitter as known in the art. In the DVC encoder 100, the source video signal 91 is received by a source signal processor 105, which obtains therefrom the source frame data X comprised of source frame values X(i), X={X(i)}={X(1), X(2), . . . , X(I)}, which represent the image content of a frame of the source video signal or of a portion thereof, wherein I is the number of the frame values in the frame data X. Depending on implementation, these source frame values X(i) may be in the form of pixel values, such as values representing pixel intensity and/or color, or they may be in the form of transform coefficients if the input data receiver 105 performs a lossless transform of the input signal as known in the art. The source frame data 107 are then provided to a data truncator (DT) 110, which converts the source frame values X(i) into truncated frame values Xₜᵣ(i), which correspond to least significant digits of the frame values X(i) in a base B numeral system, as described hereinabove with reference to equation (7) and FIG. 3. The DT 110, which is a feature of the present invention, is also referred to herein as the base-B encoder 110, and is configured for receiving a feedback signal indicative of the base B from a DVC receiver 65. The truncated frame data 117 are provided to a transmitter signal generator (TSG) 180, which is also referred to herein as the output data processor 180, for forming therefrom a transmitter signal 195, which is then sent to the signal transmitting unit 190 for transmitting to the DVC receiver 65, for example wirelessly. The DVC transmitter 55 also includes the signal receiving unit 185 for receiving a feedback signal 128 from the DVC decoder 200. The feedback signal 128 carries information indicative of the base B, and is provided to the DT 110 in the DVC encoder 100 for computing the truncated frame values X.

At the DVC receiver 65, the transmitter signal 195 is received by the signal receiving unit 201, and then provided to the DVC decoder 200, for example in the form of received baseband signal. The DVC decoder 200 includes a side information generator (SIG) 240 for generating the side information Y, an error estimator (EE) 230 for computing an estimate Eₘ of the maximum side information error Eₘₐₓ, a DT block 250, which may be substantially identical to the DT block 110 of the DVC transmitter 100, for computing the truncated side information Yᵣ, and an output data processor 270. The side information Y is an approximation to the source frame data X, and may be computed by interpolation or extrapolation from preceding and/or following frames as known in the art of DVC systems. In operation, the EE 230 computes an estimate Eₘ of the maximum side information error Eₘₐₓ, and obtains therefrom the base B, for example using equation (5), i.e. B=2(Eₘ+1). The value of B is than communicated by the signal transmitting unit 202 with the feedback signal 128 to the DVC encoder 100 of the DVC transmitter 55, and is used therein to truncate the source frame values X as described hereinabove.

The DVC decoder 200 further includes an input signal processor (ISP) 205, which connects to a frame data restore (FDR) block 210, which is also referred to herein as the base-B decoder 210, and which in turn connects to an optional output signal processor (OSP) 270. The ISP 205 receives the transmitter video signal 195 and obtains therefrom the truncated frame values Xᵣₜᵣ, which for a successful transmission should be identical, or at least suitably close to, the source truncated values Xₜᵣ. The received truncated frame values Xᵣₜᵣ are then provided to the FDR block 210, which performs the base-B decoding operation of restoring the source frame values from the received truncated frame values Xᵣₜᵣ based on the side information Y and the error estimate Eₘ, and also using the truncated side information Yₜᵣ obtained from the DT 250. These restored frame values will be denoted as Xᵣ, and referred to herein also as the received full-length frame values. They may be computed based on the following equations (11), (12),

X=Y+q, (11)

q=Eₘₐₓ−(Yₜᵣ−Xₜᵣ+Eₘₐₓ)mod B, (12)

which can be obtained from equations (8), (9) by substituting Xᵣ, Xᵣₜᵣ, and Eₘ for X, Xₜᵣ, and Eₘₐₓ, respectively.

The optional OSP 270 may be used to form a restored video signal 260 from the restored frame values Xᵣ for presenting to a user in a desired format.

The DVC encoder 100 and the DVC decoder 200 may be implemented using software modules that are executed by a hardware processor such as a microprocessor, a DSP, a general purpose processor, etc., coupled to memory, or as hardware logic, e.g., an ASIC, an FPGA, etc. The DVC transmitter 55 and the DVC receiver 65 may communicate across network that may include any combination of a local area network (LAN) and a general wide area network (WAN) communication environments, such as those which are commonplace in offices, enterprise-wide computer networks, intranets, and the Internet. Each computing device 102 and 106 includes a respective processor coupled to a system memory.

Advantageously, the adaptive differential representation of the source data as described hereinabove with reference to FIGS. 3-5, enables the transmission of less bits per frame value, and thus may eliminate the need for error-correction channel coding prior to the transmission. In such embodiments, the data truncator DT 110 effectively replaces the channel coder at the output of a standard Slepian-Wolf encoder, such as that described in B. Girod et al, Distributed Video Codieng, Proc. IEEE, vol. 93, no. 1, January 2005, and references cited therein, G. Huchet et al, DC-Guided Compression Scheme for Distributed Video Coding, 2009, CCECE '09. Canadian Conference on Electrical and Computer Engineering, and U.S. Pat. No. 7,388,521. However, in other embodiments the DT 110 of the present invention may be followed by a channel encoder.

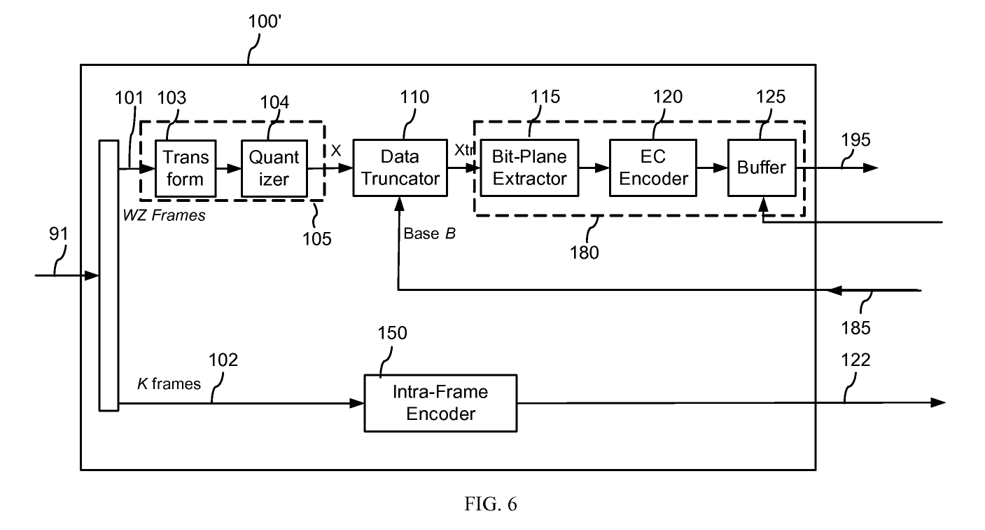

With reference to FIG. 6, a DVC encoder 100′ is illustrated in accordance with an embodiment of the present invention. Note that architecturally same elements in FIGS. 6 and 5 are labelled with same reference numerals, and are not described further hereinbelow unless they perform additional or different functions. In the shown embodiment, the DVC encoder 100′ follows a standard architecture of a Wyner-Ziv encoder, as described for example in B. Girod et al, Distributed Video Coding, Proc. IEEE, vol. 93, no. 1, January 2005, and references cited therein, Aaron et al., ‘Transform-Domain Wyner-Ziv Codec for Video’, Proc. SPIE Visual Communications and Image Processing, San Jose, Calif., 2004, U.S. Pat. No. 7,414,549, all of which are incorporated herein by reference. The DVC encoder 100′ may be considered an embodiment of the DVC encoder 100, wherein the input data processor 105 includes a transform block 103 for performing a lossless transform operation such as the DCT as known in the art, and a quantizer 104, and wherein the output data processor 180 is embodied in the form of a Slepian-Wolf (SW) encoder including a bit plane extractor 115, an error correcting (EC) channel encoder (ECE) 120, such as a turbo encoder, for example a Rate Compatible Punctured Turbo code (RCPT) encoder, or an LDPC encoder, and a buffer 125. Furthermore, the DVC encoder 100′ includes an intra-frame encoder 150 for encoding K frames as described hereinbelow. The encoding architecture of the DVC encoder 100′ differs however from a conventional Wyner-Ziv encoder in that it includes the data truncator, or the base-B encoder, 110 that is connected between the quantizer 104 and the Slepian-Wolf encoder 180.

According to the standard architecture of the Wyner-Ziv encoder, the source video signal 91 is split into a sequence of so called Wyner-Ziv frames 101, hereinafter referred to as WZ frames, and a sequence of key frames 102, hereinafter referred to as K frames, which are statistically correlated, so that there is t WZ frames between each two consecutive K frames, wherein t may be 1, 2, 3, etc. By way of example and for certainty, we will assume hereinbelow that t=1, so that there is a single WZ frame between two consecutive K frames, although it will be appreciated that the invention is equally applicable to embodiments wherein t>1. In general, there is a limitation for the maximum number of Wyner-Ziv frames for each key frame, because too few key frames and too many Wyner-Ziv frames may cause loss of coherency for maintaining a reasonable decoding quality. The WZ frames 101 are intra-frame encoded, but are then inter-frame decoded using the side information at the DVC decoder 200′ illustrated in FIG. 6. The K frames 102 are encoded by an intra-frame encoder 150, and then transmitted to the DVC decoder 200′, wherein they are decoded with a corresponding intra-frame decoder such and then used for generating the side information for WZ frames by interpolation or extrapolation as known in the art. The intra-frame encoder 150 may for example be a conventional intra-frame encoder such as an H.264 encoder including an 8×8 Discrete Cosine Transform (DCT), or any suitable intra-frame video encoder known in the art.

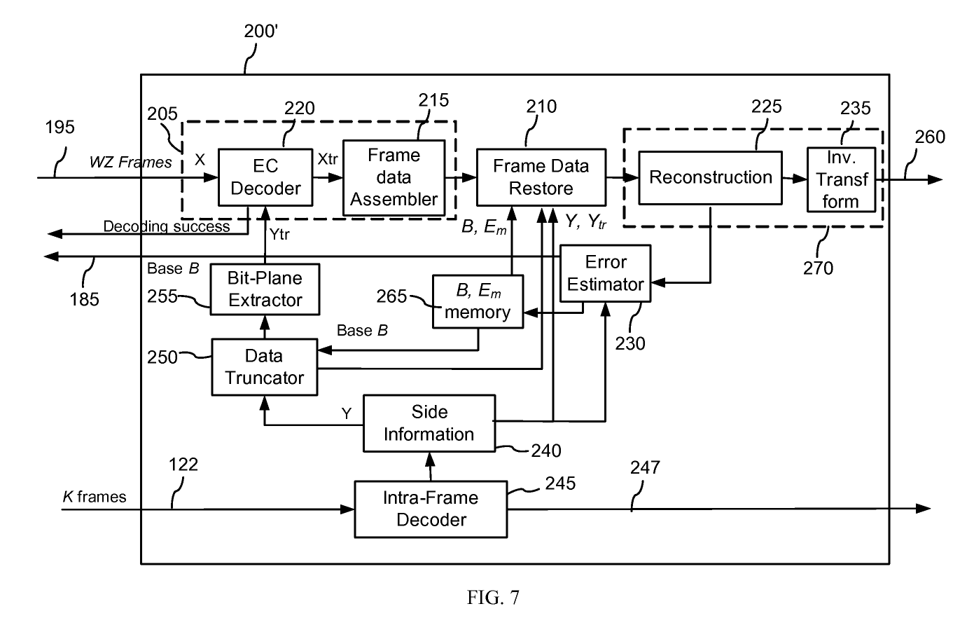

In one embodiment, the WZ frames 101 are first provided to the transform block (TB) 103, which performs a lossless transform of pixel values in each WZ frame to obtain one or more sets of transform coefficients, preferably same transform as implemented in the intra-frame encoder 150. By way of example, the TB 103 may perform the H.264 DCT, wherein each WZ frame is divided in blocks of 4×4 pixels. The modified DCT transform of H.264 standard is then applied to each such block, so that 16 different transform coefficients, associated with 16 frequency bands, are computed. Transform coefficients of these bands are then processed separately, until they are recombined with a reciprocal inverse transform at the DVC decoder 200′ illustrated in FIG. 7. The aim of this transform is to enable a better data compression as known in the art. In other embodiments, other types of suitable lossless transforms may be utilized, including but not limited to the wavelet transform, Fourier Transform, K-L transform, Sine Transform, and Hadamard transform. In other embodiments, the TB 103 may be omitted, so that all further processing is performed on pixel values of the WZ frames.

After the optional TB 103, the transform coefficients in the k-th band, or pixel values in other embodiments, of the WZ frames are quantized by the quantizer 104, which for example may be embodied as the 2^{M}^{ₖ} level uniform scalar quantizer as known in the art, which divides the input data stream into cells, and provides the cells to a buffer (not shown). We note however that the presence of the quantizer 104, although usually beneficial for reducing the transmission bit rate, is not a requirement for the present invention.

In a conventional WZ encoder, a block of quantized frame data X formed of frame values X(i), each composed of n bits, would then be provided directly to the Slepian-Wolf encoder 180, where they would be first re-arranged in a sequence of n bit-planes in the bit-plane extractor 115, and then each bit-plane would be encoded in the ECE 120 using a suitable rate-adaptable EC code that generates information bits and parity bits. The information bits are discarded; the parity bits or syndrome bits are stored in a parity bit buffer 125, and sent to the DVC decoder 200′ with the transmitter signal 195, for example in timed subsets of parity bits, one subset after another, until a signal indicating successful decoding is received from the DVC decoder 200′ via a return channel.

Contrary to that, in the DVC encoder 100′ the quantized frame data X composed of n-bit frame values X(i) is first provided to the base-B encoder 110, which performs the adaptive base-B truncation of the frame data as described hereinabove with reference to equation (7) and FIGS. 3 and 5, and passes to the Slepian-Wolf encoder 180 the truncated frame data Xₜ, composed of truncated frame values Xₜᵣ (i), each expressed with at most m bits using Gray binary representation, where m=log₂(B)<n. In the Slepian-Wolf encoder 180, the truncated frame data are re-arranged in a sequence of m bit-planes Xₜᵣ^{j}, j=1, . . . m, in the bit-plane extractor 115, and then each bit-plane Xₜᵣ^{j} encoded in the ECE 120 using the rate-adaptable EC code to generate and transmit parity bits as described hereinabove for the conventional Slepian-Wolf encoder.

In one embodiment, all truncated frame values Xₜᵣ(i) computed using the same base B are outputted from the DT 110 in the form of m-bit words, and the bit-plane extractor assembles m bit planes Xₜᵣ^{j}, j=1, . . . m, each of which including a same number of bits, equal to the number of frame values in the frame data X. However, if Xₜ(i) are represented as code words of the Gray representation, the last (m−1) bits of a code word can correspond to the (m−1) bits of another code word only if Xₜᵣ(i) is superior to a threshold value S given by the following equation (13):

S=2^{m}−B−1, (13)

Accordingly, in another embodiment, the frame values Xₜᵣ(i) that are smaller than a threshold S are represented with (m−1) bits in the Gray binary representation, while the truncated frame values Xₜᵣ(i) that are equal or greater than the threshold S, are represented with m bits in the Gray binary representation; the sorting of the truncated frame values with respect to the threshold S and the variable-length Gray binary representation thereof may be performed either at the output of the DT 110, or at the input of the bit-plane extractor 115. In this embodiment, the most significant bit-plane Xₜᵣ^{m} may include less bits than the less significant bit-planes Xₜᵣ^{j}, j=1, . . . m−1, and should be processed at the Slepian-Wolf decoder of the DVC decoder 200′ after the less significant bit-planes Xₜᵣ^{j}, j=1, . . . m−1.

With reference to FIG. 7, the DVC decoder 200′ configured to receive and decode the transmitter signal 195 generated by the DVC encoder 100 is illustrated in accordance with an embodiment of the present invention. Note that architecturally same or similar elements in FIGS. 7 and 5 are labelled with same reference numerals, and are not described further hereinbelow unless they perform additional or different functions in some embodiments of the invention. As shown in FIG. 7, the DVC decoder 200′ in part follows a standard architecture of a Wyner-Ziv decoder, but includes additional components that enable the base-B decoding of received truncated frame data. Comparing to the DVC decoder 200, in the DVC decoder 200′ the input data processor 205 is substantially a Slepian-Wolf (SW) decoder, which functionality is a reverse of that of the SW encoder 180; the output data processor 270 functions substantially in reverse to the input data processor 105 of DVC receiver 100′, as known in the art. Following the standard architecture of the WZ decoder, the DVC decoder 200′ further includes an intra-frame decoder 245, such as the H.264 IDCT intra-frame decoder, which is complimentary to the intra-frame encoder 150 and operates in reverse thereto to generate decoded K frames. The decoded K frames are then used by the side information generator 240 to generate the side information Y for a WZ frame that is to be processed by the SW decoder 205, for example by interpolation and/or extrapolation of the adjacent decoded K frames as known in the art, see for example J. Ascenso, C. Brites and F. Pereira, “Content Adaptive Wyner-Ziv Video Coding Driven by Motion Activity”, Int. Conf. on Image Processing, Atlanta, USA, October 2006, and F. Pereira, J. Ascenso and C. Brites, “Studying the GOP Size Impact on the Performance of a Feedback Channel-based Wyner-Ziv Video Codec”, IEEE Pacific Rim Symposium on Image Video and Technology, Santiago, Chile, December 2007, all of which are incorporated herein by reference.

One difference between the DVC decoder 200′ and a standard WZ decoder is that the DVC decoder 200′ includes the base-B decoder, or the FDR block 210, which is connected between the input SW decoder 205 and the output data processor 270, and which functionality is described hereinabove with reference to FIG. 5; it performs the base-B decoding of the received truncated frame data Xᵣₜᵣ, as received from the SW decoder 205, to generate restored frame data X, based on the side information Y and the error estimate Eₘ for providing to the output data processor 270.

Another difference between the DVC receiver apparatus 200′ and a standard WZ decoder is that the DVC receiver apparatus 200′ includes the error estimator 230 for generating the error estimate Eₘ and the base B for the side information Y as described hereinabove with reference to FIG. 5, and the DT block 250 for generating the base-B truncated side information Yₜᵣ as described hereinabove with reference to equation (10) and FIG. 5. The DT 250 provides the truncated side information Yₜᵣ for each received WZ frame to the FDR block 210, and to a bit-plane extractor 255. The bit-plane extractor 255 operates in the same way as the bit-plane extractor 115 of the DVC encoder 100′, and converts the truncated side information Yₜᵣ in Gray binary representation into a sequence of m bit-planes Yₜᵣ^{j}, j=1, . . . m of the truncated side information Yₜᵣ to an EC decoder (ECD) 220. The ECD 220 is complimentary to the ECC 120 of the DVC encoder 100′, and utilizes the parity bits received with the transmitter signal 195 for the current WZ frame to correct the bits in the m bit-planes of the truncated side information Yₜᵣ, so as to generate m decoded bit-planes Xᵣₜᵣ^{j}, j=1, . . . , m. These m decoded bit-planes are then provided to a frame data assembler (FDA) 215 for assembling received truncated frame values Xᵣₜᵣ(i) from the decoded bit-planes Xᵣₜᵣ^{j}, j=1, . . . , m. It will be appreciated that the received truncated frame values Xᵣₜᵣ(i), although carrying at most m-bit of received information, after the FDA 215 may be represented as m-bit words or as n-bit words in preparation for the base-B decoding at the FDR 210.

In one embodiment, the SW decoder 205 formed of the ECD 220 and the FDA 215 operate generally as known in the art for a standard WZ decoder, wherein the side information is processed starting with the most significant bit-plane thereof. An advantage of the present invention, however, is that the SW decoder 205 has to process less bit-planes per frame as only the truncated frame values are encoded for transmission.

In one embodiment, the data truncators 250 and 110 output truncated data Xₜᵣ and Yₜᵣ comprised of both m-bit values and (m−1)-bit values in Gray binary representation, as described hereinabove with respect to the truncated frame values Xₜᵣ; in this embodiment the SW decoder 205 may operate differently from a standard SW decoder, in that the ECD 220 preferably processes the most significant bit-plane Yₜᵣ^{m} of the truncated side information Yₜᵣ prior to the less significant bit-planes Yₜᵣ^{j}, j=1, . . . m−1. Advantageously, in this embodiment the amount of the transmitted information per frame of the source video signal, and therefore the bitrate of the transmission signal is further decreased.

The SW decoder 205 outputs the received truncated frame values Xᵣₜᵣ, which for a successful transmission should be identical, or at least suitably close to, the source truncated values Xₜᵣ. The received truncated frame values Xᵣₜᵣ are then provided to the FDR block 210, which performs the base-B decoding operation of restoring the source frame values from the received truncated frame values Xᵣₜᵣ based on the side information Y and the error estimate Eₘ, and also using the truncated side information Yₜᵣ obtained from the DT 250 as described hereinabove with reference to FIG. 5 and equations (11), (12).

The FDR 210 outputs the restored n-bit frame values Xᵣ which are then provided to the output data processor 270, which may operate as known in the art to generate an output video signal 260 in a desired format for providing to the user. In the shown embodiment, the ODP 270 includes a reconstruction block 225 for performing the reconstruction of the transform coefficients from the restored n-bit frame values Xᵣ, which are substantially decoded quantized transform coefficients, as known in the art, followed by an inverse transform block 235 which performs the inverse lossless transform, such as the H.264 IDCT or the like. Reconstructed WZ frames may be further used to reconstruct the source video signal using the decoded K frames 247 for user presentation.

In embodiments wherein the DVC encoder 100′ lacks the transform block 103, and therefore operates in pixel domain to encode the frame data X comprised of quantized pixel values, the inverse transform block 235 is also absent in the DVC decoder 200′. In such embodiments, the intra-frame decoder 245 will output decoded K frames composed of pixel values rather than transform coefficients.

The error estimator may utilize preceding WZ frames that have already been decoded for estimating the maximum side information error Eₘₐₓ for a following WZ frame, prior to the base-B encoding thereof at the DVC encoder 100′. In one embodiment, restored frame data Xᵣ^{l} of an l-th decoded WZ frame is provided to the EE 230 along with the side information Y^{l} for said frame. The EE 230 than computes a maximum error of the side information for this frame according to the following equation (cf equation (6)):

Eₘₐₓ(l)=max {|X^{l}−Y^{l}|}≡maxᵢ {|X^{l}(i)−Y^{l}(i)|}, (13)

This value then can be used as the error estimate Eₘ for a following, e.g. (l+p)^{th} WZ frame, which has not yet been encoded by the DVC encoder 100′, where p can be 1, 2, etc. In a variation of this embodiment, the error estimator may save in memory the estimates given by equation (13) for several consecutive decoded WZ frames, and then use an extrapolation procedure to generate the error estimate Eₘ for a subsequent WZ frame yet to be encoded. Once the error estimate Eₘ for the (l+p)th WZ frame is computed, it is used by the EE 230 to compute the base B for that frame. This base value B is then communicated to the DVC encoder 100′ with the feedback signal 185, for example wirelessly via a return channel. The EE 230 may also save the computed Eₘ and B values in memory 265, for providing to the DT 250 and the FDR 210 for use in decoding of the (1+p)th WZ frame after it has been encoded in the DVR encoder 100′ and the corresponding parity bits are received by the DVC decoder 200′ with the transmitter signal 195. A first WZ frame in a new sequence of frames may be transmitted by the DVC transmitter without the base-B encoding step, i.e. as in a conventional WZ encoder. In one embodiment, the value of the base B updated in memory 265 and transmitted to the DVC encoder 100′ only if a newly generated error estimate Eₘ differs from a preceding one.

The aforedescribed process of generating the error estimate Eₘ, and computing the base value B therefrom for communicating to the DVC encoder for performing the base-B encoding of the source frame data can be repeated on a per-frame basis for each WZ frame, for a group of WZ frames, or more than once per a WZ frame, so that different values of the base B can be used for subs-sets of the source frame data, for example different base values B can be used to transmit different frequency bands for a frame. Accordingly, the number of bit-planes generated and encoded at the DVC encoder 100′ varies adaptively to the image content of successive frames for reducing the amount of information that needs to be transmitted, and therefore the bit rate.

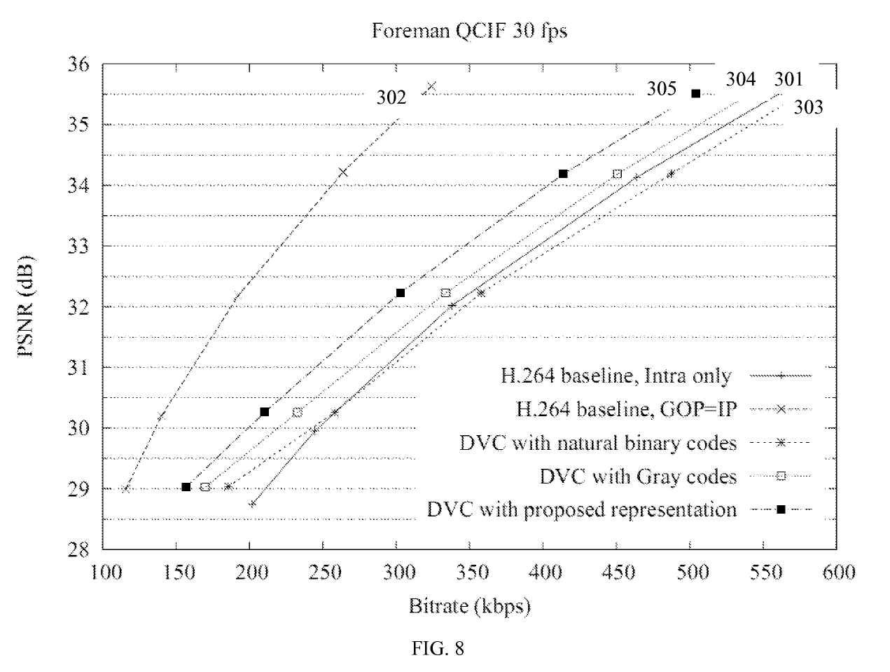

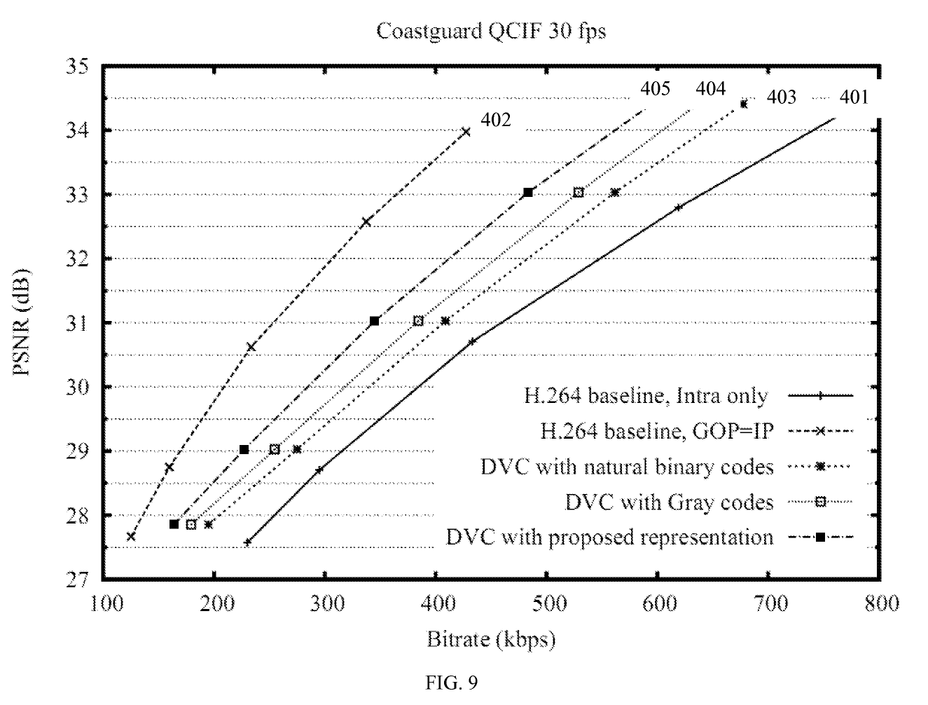

FIGS. 8 and 9 illustrate the rate-distortion performance, i.e. the PSNR vs. bitrate, for the Foreman and the Coastguard video test sequences, respectively, for 5 different video codecs. Simulations were performed using the QCIF format at 30 fps for 101 frames. Curve 305 and 405 illustrate the performance of the DVC system according to the present invention. For comparative purpose, also shown are the base-line performance of the H.264 standard video codec using only the I (intra) frames (301, 401), i.e. without any motion prediction or compensation, and with GOP=IP, i.e. one prediction frame per each intra frame (302, 402), which provides good bit-rate performance but requires long and complex encoding at the transmitter. Curves 303, 403 and 304, 404 show the performance of the prior art WZ encoders utilizing the natural binary (303, 403) and the Gray (304, 404) representations of the frame data for generating the bit-planes. One to one ration of the K frames and the WZ frames was used in the simulations for the DVC systems.

As can be seen from the graphs, utilizing the adaptive base truncation of frame data according to the present invention provides up to 0.6-0.8 dB improvement in the PSNR for high bitrates over Gray codes representation and more than 1 dB improvement over the natural binary representation.

The invention has been fully described hereinabove with reference particular embodiments thereof, but is not limited to these embodiments. Of course, those skilled in the art will recognize that many modifications may be made thereto without departing from the present invention. It should also be understood that each of the preceding embodiments of the present invention may utilize a portion of another embodiment.

Of course numerous other embodiments may be envisioned without departing from the spirit and scope of the invention.

We claim:

1. A method for encoding source video signal in a distributed video coding (DVC) system comprising a DVC transmitter and a DVC receiver, the DVC receiver comprising a DVC decoder utilizing side information for decoding received video signal, the method comprising:
a) obtaining, at the DVC transmitter, source frame data X from the source video signal, the source frame data X comprising source frame values for a frame of the source video signal;
b) obtaining a base B for the source frame data X, wherein the base B is an integer number generated in dependence on an error estimate Eₘ for side information Y obtained at the DVC receiver for the source frame data X;
c) truncating the source frame data X to obtain truncated frame data Xₜᵣ comprised of truncated frame values, wherein each truncated frame value corresponds to a least significant digit of one of the source frame values in a base B numeral system; and,
d) generating a transmitter video signal from the truncated frame data Xₜᵣ for transmitting to the DVC receiver.

2. The method of claim 1, wherein step b) comprises receiving, from the DVC receiver, information indicative of the base B at the DVC transmitter.

3. The method of claim 1, wherein step c) comprises computing for each of the source frame values a remainder on division thereof by B, and representing said remainder with at most m bits, wherein m is a smallest integer no less the log₂(B).

4. The method of claim 3, wherein step d) comprises converting the truncated frame data Xₜ, into a sequence of m bit-planes.

5. The method of claim 4, wherein step d) comprises using a Gray binary representation for the truncated frame data Xₜᵣ.

6. The method of claim 3, wherein step d) comprises encoding the truncated video signal using an error correction code.

7. The method of claim 1, wherein the source frame values comprise one of quantized pixel values or quantized transform coefficients.

8. The method of claim 5, wherein step d) comprises
representing truncated frame values that are less than a threshold value S with (m−1) bits, and representing truncated frame values that are greater than the threshold value S with m bits, wherein S=2^{m}−B−1.

9. The method of claim 8, wherein step (d) further comprises encoding each of the m bit-planes using an error correction code to generate a plurality of parity symbols for transmitting to the DVC receiver with the transmitter video signal.

10. The method of claim 1, further comprising:
e) obtaining at the DVC receiver the side information Y for the source frame data X, said side information comprising side information values;
f) obtaining at the DVC receiver the error estimate Eₘ for the side information Y;
g) computing the base B from the error estimate Eₘ, and transmitting information indicative of the base B to the DVC transmitter;
h) receiving the transmitter video signal at the DVC receiver and obtaining therefrom the truncated frame data Xₜᵣ corresponding to the source frame data X;
i) restoring the source frame data from the received truncated frame data to obtain restored frame data X, using the side information Y and the error estimate Eₘ; and,
j) forming an output video signal from the restored frame data for presenting to a user.

11. The method of claim 10, wherein step i) comprises:
computing truncated side information Yₜᵣ, comprising truncated side information values Yₜᵣ corresponding to least significant digits of the side information values in the base B numeral system; and,
computing a correction q to the side information Y in accordance with an equation q=Eₘ−(Yₜᵣ−Xᵣₜᵣ+Eₘ) mod B.

12. The method of claim 11, wherein step d) comprises encoding the truncated frame data Xₜᵣ using an error correction code, and step h) comprises decoding the transmitter video signal using the truncated side information.

13. The method of claim 11, wherein:
step d) comprises encoding bit-planes of the truncated frame data using an error correction code, wherein a most significant bit-plane includes less bits than less significant bit planes, and
step h) comprises decoding the most significant bit-plane after the less significant bit-planes.

14. An apparatus for encoding a source video signal in a distributed video coding (DVC) system, the apparatus comprising:
a source signal processor for receiving the source video signal and for obtaining therefrom source frame data X comprising source frame values for a frame of the source video signal;
a data truncator for converting the source frame values into truncated frame values to generate truncated frame data Xₜᵣ, wherein the truncated frame values correspond to least significant digits of the source frame values in a base B numeral system, the data truncator configured for receiving a feedback signal indicative of the base B from a DVC receiver; and,
a transmitter signal generator for generating a transmitter video signal from the truncated frame values for transmitting to the DVC receiver.

15. The apparatus of claim 14, wherein:
the data truncator is configured to represent the truncated frame values with at most m bits, wherein m is a smallest integer no less than log 2(B); and,
the transmitter signal generator comprises:
a bit plane extractor for converting the truncated frame data into a sequence of m bit planes, and
an error correction encoder for encoding the bit planes to generate a plurality of parity symbols for forming the transmitter video signal.

16. The apparatus of claim 15, wherein the source signal receiver comprises at least one of: a quantizer, and a lossless transformer.

17. An apparatus for decoding the transmitter video signal generated by the apparatus of claim 14, the receiver apparatus comprising:
a side information generator for generating side information Y for the source frame data X, the side information comprising side information values related to the source frame values;
an error estimator for estimating an error Eₘ of the side information Y, and for computing therefrom the base B for communicating to the transmitter apparatus;
an input signal processor for receiving the transmitter video signal and obtaining therefrom received truncated frame data Xᵣₜᵣ; and,
a frame data restorer coupled to the side information generator and the error estimator for computing restored frame data Xᵣ from the received truncated frame data Xᵣₜᵣ based on the side information Y and the error estimate Eₘ.

18. A receiver apparatus for decoding the transmitter video signal generated by the transmitter apparatus of claim 15, the receiver apparatus comprising:
a side information generator for generating side information Y for the source frame data X, the side information comprising side information values related to the source frame values;
an error estimator for estimating an error Eₘ of the side information Y, and for computing therefrom the base B for communicating to the transmitter apparatus;
a data truncator for truncating the side information Y to generate truncated side information Yₜᵣ in dependence on the base B;
a bit extractor for extracting bit planes from the truncated side information Yₜᵣ;
an input signal processor for receiving the transmitter video signal and obtaining therefrom received truncated frame data Xᵣₜᵣ; and,
a frame data restorer coupled to the side information generator and the error estimator for computing restored frame data Xᵣ from the received truncated frame data Xᵣₜᵣ based on the side information Y and the error estimate Eₘ,
wherein the input signal processor comprises:
an error correction decoder coupled to the bit extractor for correcting the bit-planes of the truncated side information using the plurality of parity symbols received with the transmitter video signal, and obtaining therefrom a sequence of corrected bit planes, and
a frame data assembler for assembling truncated frame values from the sequence of corrected bit planes.

19. The apparatus of claim 18, wherein the frame data restorer is configured to compute the restored frame data Xᵣ based on a following equation: Xᵣ=Y+Eₘ−(Yₜᵣ−Xᵣₜᵣ+Eₘ) mod B.
